(19) United States
(12) Patent Application Publication
(10) Pub. No.: US 2017/0052140 A1
(43) Pub. Date: Feb. 23, 2017

(54) GAS SENSOR

(71) Applicant: NGK SPARK PLUG CO., LTD., Nagoya-shi (JP)

(72) Inventors: Kunihiko YONEZU, Inuyama-shi (JP); Takehiro OBA, Konan-shi (JP)

(73) Assignee: NGK SPARK PLUG CO., LTD., Nagoya-shi (JP)

(21) Appl. No.: 15/234,387

(22) Filed: Aug. 11, 2016

(30) Foreign Application Priority Data
Aug. 20, 2015 (JP) 2015-162505

(51) Int. Cl. G01N 27/409; G01N 27/407; G01N 27/41; F01N 11/00

(52) U.S. Cl. CPC G01N 27/409; F01N 11/007; G01N 27/4073; G01N 27/4075; G01N 27/41; G01N 27/4071

(57) ABSTRACT

A gas sensor including: a detection element extending in an axial direction; a tubular metal shell surrounding a periphery of the detection element; and a powder-charged layer disposed between an outer surface of the detection element and an inner surface of the metal shell such that the powder-charged layer is in direct contact with the inner surface of the metal shell. The metal shell has a groove having an opening formed on an outer surface of the metal shell in a circumferential direction thereof, and in the axial direction, one-half or more of the opening is located between a center portion that is a center of the powder-charged layer and a front end, in the axial direction, of the powder-charged layer.

### BACKGROUND OF THE INVENTION

1. Field of the Invention

The present invention relates to a gas sensor having a metal shell having a small thickness in the radial direction which resists deformation.

2. Description of the Related Art

Hitherto, a gas sensor mounted onto an intake system or an exhaust system for an internal combustion engine (e.g., a diesel engine or a gasoline engine) is known. The gas sensor is used for detecting the concentration of a specific gas component (e.g., oxygen or NOx) in a measurement target gas (e.g., Patent Document 1). The gas sensor disclosed in Patent Document 1 includes: a detection element having a gas detection portion at a front side in an axial direction; a tubular metal shell (housing) surrounding the periphery of the detection element; and a laminate member for holding the detection element within the metal shell. The laminate member includes a powder-charged layer (talc ring) formed by compressing and solidifying a talc powder. A groove for disposing a seal member is formed on the outer circumferential surface of the metal shell and along the circumferential direction. In general, a portion of the metal shell on which the groove is formed is thinner in a radial direction than other portions of the metal shell.
[Patent Document 1] Japanese Patent No. 5485931

3. Problems to be Solved by the Invention

The powder-charged layer is formed by placing talc powder into the metal shell and then pressing the talc powder from the rear side toward the front side in the axial direction. Thus, when forming the powder-charged layer, the pressure in a charged region within the metal shell in which the talc powder is located becomes high. Since the pressure in the charged region becomes high, a pressure toward the outer side in the radial direction is applied by the talc powder to the metal shell at a portion at which the metal shell and the talc powder are in direct contact with each other. Accordingly, the metal shell may deform. In particular, an upper portion (a rear portion in the axial direction) in the charged region is close to a point at which the pressure for forming the powder-charged layer is directly applied. Thus, the pressure in the upper portion of the charged region becomes higher than the pressure in a lower portion of the charged region. Consequently, there is a possibility that a degree of deformation of a portion of the metal shell that is in contact with the upper portion in the charged region becomes high. When the metal shell has deformed, a member (e.g., the powder-charged layer) disposed within the metal shell may have a value which deviates from a design value (e.g., compression degree).

In order to inhibit deformation of a portion (groove-formed portion) of the metal shell on which the groove is formed, a method of increasing the thickness of the groove-formed portion may be contemplated. However, in this method, the size of the metal shell may be increased in the radial direction.

Thus, there is a demand for a technique that inhibits deformation of the metal shell without having to increase the metal thickness of the shell in the radial direction. Such a demand is common not only with respect to a metal shell having a groove formed for disposing a seal member therein, but also to a gas sensor including a metal shell having a portion (thin portion) having a small thickness in the radial direction.

### SUMMARY OF THE INVENTION

The present invention has been made to solve the above-described problems, and an object thereof is to provide a gas sensor and technique that is able to resist deformation while inhibiting an increase in the thickness of the metal shell.

In accordance with a first aspect (1), the above object of the present invention has been achieved by providing a gas sensor which includes: a detection element extending in an axial direction and having, at a front side in the axial direction, a detection portion for detecting a concentration of a specific gas; a tubular metal shell surrounding a periphery of the detection element; and a powder-charged layer disposed between an outer surface of the detection element and an inner surface of the metal shell such that the powder-charged layer is in direct contact with the inner surface of the metal shell. The metal shell has a groove having an opening formed on an outer surface of the metal shell in a circumferential direction thereof, and in the axial direction, one-half or more of the opening is located between a center portion that is a center of the powder-charged layer and a front end, in the axial direction, of the powder-charged layer.

According to this aspect, one-half or more of the opening of the groove is located in a range (front end range) between the center portion and the front end of the powder-charged layer. Consequently, pressure applied to a portion of the metal shell, located in the front end range, during formation of the powder-charged layer can be made lower than the pressure applied to a portion of the metal shell, located in a rear end range that is a range between the center portion and a rear end of the powder-charged layer. Thus, without increasing the thickness, in the radial direction, of a portion (groove-formed portion) of the metal shell at which the groove is located, deformation of the groove-formed portion during formation of the powder-charged layer can be inhibited.

In a preferred embodiment (2) of the gas sensor according to (1) above, a seal member for sealing a gap between the metal shell and a mounting target on which the gas sensor is to be mounted is disposed in the groove. According to this aspect, the gap between the mounting target and the metal shell can be sealed by the seal member.

In another preferred embodiment (3) of the gas sensor according to (1) or (2) above, the groove has a bottom surface opposed to the opening in a radial direction. According to this aspect, a groove having a bottom surface can be provided.

In yet another preferred embodiment (4) of the gas sensor according to any of (1) to (3) above, an entirety of the groove is located between the center portion and the front end of the powder-charged layer. According to this aspect, the groove can be provided at a portion at which pressure applied to the metal shell in forming the powder-charged layer is lower. Thus, without increasing the thickness, in the radial direction, of the portion (groove-formed portion) of the metal shell at which the groove is located, deformation of the groove-formed portion during formation of the powder-charged layer can be further inhibited.

In yet another preferred embodiment (5), the gas sensor according to any of (1) to (4) above further includes: a first member having a first insertion hole into which the detection element is inserted, the first member being disposed within the metal shell and at a rear side in the axial direction with respect to the powder-charged layer, the detection element having been inserted into the first insertion hole so as to compress the powder-charged layer; and a second member having a second insertion hole into which the detection element is inserted, the second member being disposed within the metal shell and at the front side in the axial direction with respect to the powder-charged layer, the detection element having been inserted into the second insertion hole, to compress the powder-charged layer, and an area S2 of a surface perpendicular to the axial direction, of a surface of the second member that is in contact with the powder-charged layer, is larger than an area S1 of a surface perpendicular to the axial direction, of a surface of the first member that is in contact with the powder-charged layer. According to this aspect, since the area S2 is larger than the area S1, the pressure applied to the front side of the metal shell can be decreased, so that deformation of the metal shell (particularly, the groove-formed portion) can be further inhibited.

In a second aspect (6), the present invention provides a gas sensor which includes: a detection element extending in an axial direction and having, at a front side in the axial direction, a detection portion for detecting a concentration of a specific gas; a tubular metal shell surrounding a periphery of the detection element; and a powder-charged layer disposed between an outer surface of the detection element and an inner surface of the metal shell such that the powder-charged layer is in direct contact with the inner surface of the metal shell, wherein the metal shell has, in the axial direction, a thin portion having a smallest thickness in a radial direction, of a portion that at least partially overlaps the powder-charged layer, and in the axial direction, one-half or more of the thin portion is located between a center portion that is a center of the powder-charged layer and a front end, in the axial direction, of the powder-charged layer.

According to this aspect, one-half or more of the thin portion is located between the center portion and the front end of the powder-charged layer (in a front end range). Consequently, pressure applied to a portion of the metal shell, located in the front end range, during formation of the powder-charged layer can be made lower than the pressure applied to a portion of the metal shell, located in a rear end range. Thus, without increasing the thickness, in the radial direction, of the thin portion of the metal shell, deformation of the thin portion during formation of the powder-charged layer can be inhibited.

In a preferred embodiment (7) of the gas sensor according to (6) above, a seal member for sealing a gap between the metal shell and a mounting target on which the gas sensor is to be mounted is disposed at the thin portion. According to this aspect, the gap between the mounting target and the metal shell can be sealed by the seal member.

In another preferred embodiment (8) of the gas sensor according to (6) or (7) above, the thin portion has an outer surface extending in the axial direction. According to this aspect, a thin portion having an outer surface can be provided.

In yet another preferred embodiment (9) of the gas sensor according to any of (6) to (8) above, an entirety of the thin portion is located between the center portion and the front end of the powder-charged layer. According to this aspect, the thin portion can be provided at a portion at which the pressure applied to the metal shell in forming the powder-charged layer is lower. Thus, deformation of the thin portion during formation of the powder-charged layer can be further inhibited without increasing the thickness, in the radial direction, of the thin portion of the metal shell.

In yet another preferred embodiment (10), the gas sensor according to any of (6) to (9) above further includes: a first member having a first insertion hole into which the detection element is inserted, the first member being disposed within the metal shell and at a rear side in the axial direction with respect to the powder-charged layer, the detection element having been inserted into the first insertion hole so as to compress the powder-charged layer; and a second member having a second insertion hole into which the detection element is inserted, the second member being disposed within the metal shell and at the front side in the axial direction with respect to the powder-charged layer, the detection element having been inserted into the second insertion hole so as to compress the powder-charged layer, and an area S2 of a surface perpendicular to the axial direction, of a surface of the second member that is in contact with the powder-charged layer, is larger than an area S1 of a surface perpendicular to the axial direction, of a surface of the first member that is in contact with the powder-charged layer. According to this aspect, since the area S2 is larger than the area S1, the pressure applied to the front side of the metal shell can be decreased, so that deformation of the metal shell (particularly, the thin portion) can be further inhibited.

The present invention can be embodied in various forms. For example, other than a gas sensor, the present invention can be embodied in forms such as a metal shell and a method for manufacturing a gas sensor or a metal shell.

### BRIEF DESCRIPTION OF THE DRAWINGS

FIG. 1 is a cross-sectional view of a gas sensor according to a first embodiment of the present invention.

FIG. 2 is a perspective view of a terminal housing unit.

FIG. 3 is a perspective view of a detection element.

FIG. 4 is a chart of a process for forming a powder-charged layer.

FIG. 5 is a partially enlarged view of the gas sensor according to the first embodiment.

FIG. 6 is a cross-sectional view of a gas sensor according to a second embodiment of the present invention.

### DESCRIPTION OF REFERENCE NUMERALS

Reference numerals used to identify various features in the drawings include the following.
10: terminal housing unit
15: attachment portion
16, 16a: metal shell
16fa: inner surface
16fb: outer surface
17: protector
18: external protector
19: internal protector
20: detection element
20fa: first plate surface
20fb: second plate surface
21: detection portion
22: element rear end portion
24: metal terminal portion
24a: first metal terminal portion
24b: second metal terminal portion
24c: third metal terminal portion
24d: fourth metal terminal portion
24e: fifth metal terminal portion
28: element layer
29: heater layer
30: separator portion
31: bottom portion
34a: first housing space portion
34b: second housing space portion
34c: third housing space portion
34d: fourth housing space portion
34e: fifth housing space portion
34f: sixth housing space portion
35: partition
40: base portion
41: main body portion
44: side portion
50: connector portion
52: connector terminal
54: one end portion
56: another end portion
58: opening portion
60: connection terminal
60a: first connection terminal
60b: second connection terminal
60c: third connection terminal
60d: fourth connection terminal
60e: fifth connection terminal
80: seal member
81: suction pipe
90: detection portion protection layer
157: crimp ring
158, 158a: seal member
162, 162a: groove
163, 163a: thin portion
164: rear end portion
165: opening
165A: first end portion
165B: second end portion
166: bottom surface
167: front-side outer circumferential portion
168: rear-side outer circumferential portion
169: ledge portion
171: ceramic sleeve
171H: first insertion hole
171P: flat portion
173: powder-charged layer
175: ceramic holder
175H: second insertion hole
175P: flat portion
200, 200a: gas sensor
411: groove
AS: front side
BS: rear side
CD: axial direction
PAt: front end
PBt: rear end
PMt: center portion
Ra: first range
Rb: front end range

### DETAILED DESCRIPTION OF THE PREFERRED EMBODIMENTS

The present invention will next be described in greater detail with reference to the drawings. However, the present invention should not be construed as being limited thereto.

### A. First Embodiment

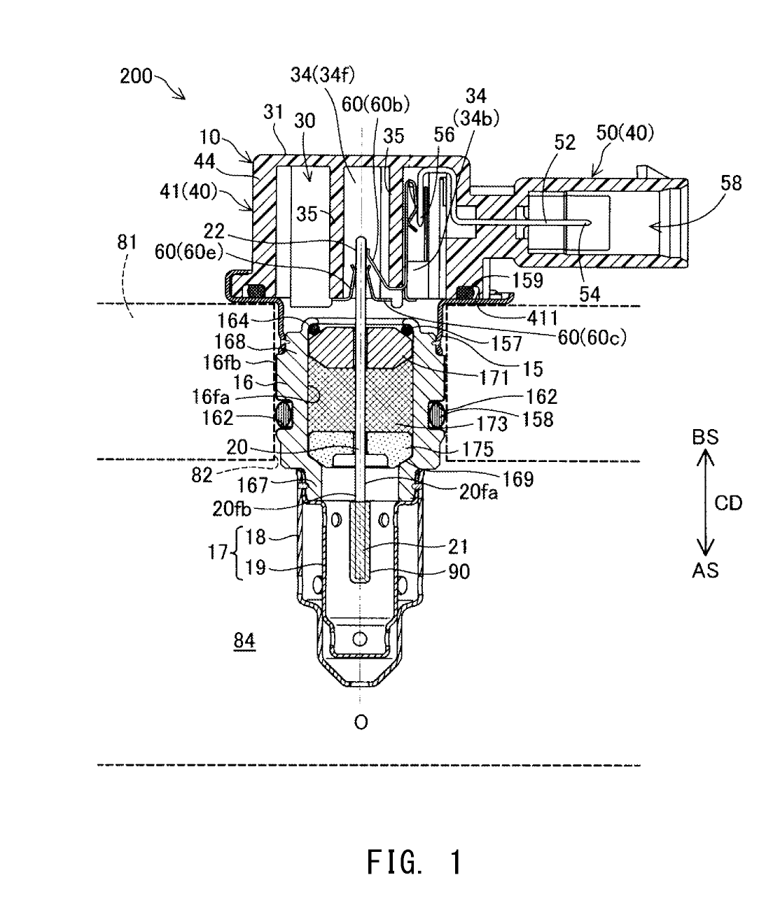

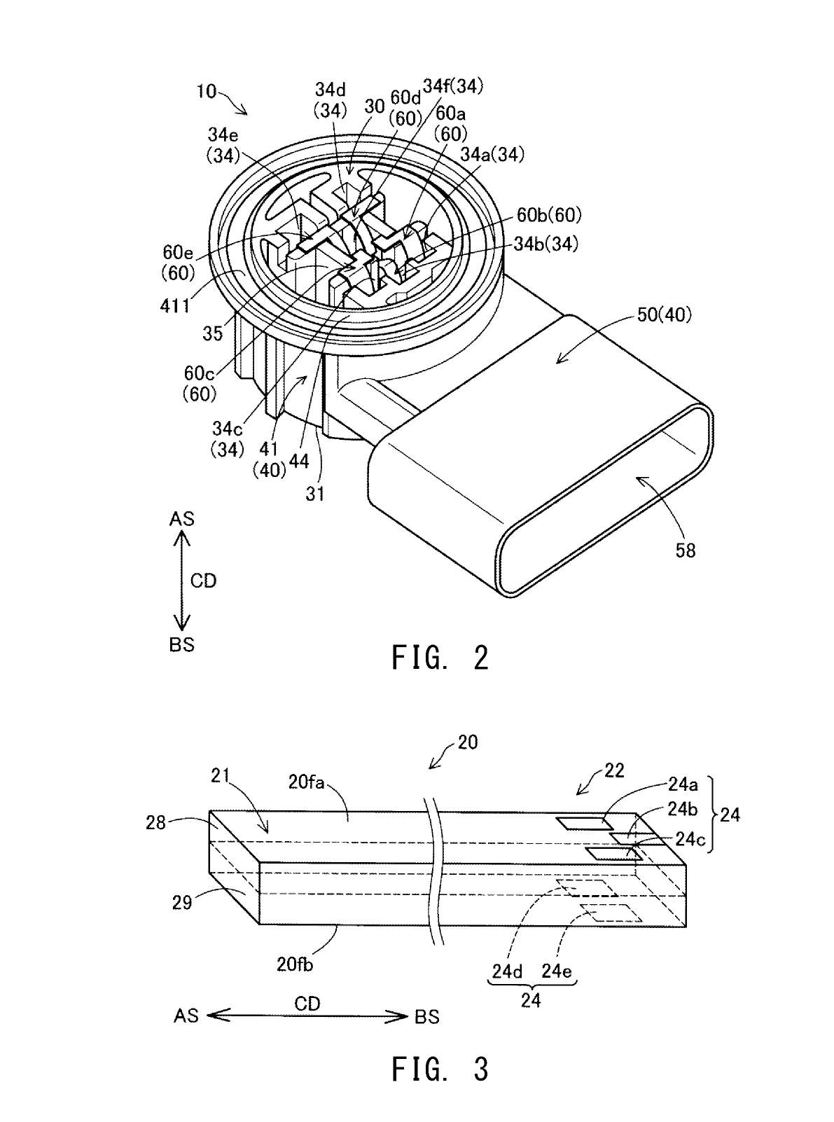

FIG. 1 is a cross-sectional view of a gas sensor 200 according to a first embodiment of the present invention. FIG. 2 is a perspective view of a terminal housing unit 10. FIG. 3 is a perspective view of a detection element 20. In FIG. 1, a direction parallel to an axial line O of the detection element 20 is defined as an axial direction CD, the upper side on the sheet surface is defined as a rear side BS of the gas sensor 200, and the lower side on the sheet surface is defined as a front side AS of the gas sensor 200.

The gas sensor 200 (FIG. 1) is mounted on, for example, an intake system (e.g., an intake pipe) of an internal combustion engine, and outputs a detection signal for detecting a specific gas concentration (oxygen concentration) of an intake gas drawn in through the intake system. The gas sensor 200 according to the present embodiment measures the oxygen concentration of the intake gas that is to be used for air-fuel ratio control or the like of an engine. The gas sensor 200 is mounted on an intake pipe 81 of an engine using a mounting mechanism that is not shown (e.g., a screw). The front side AS of the gas sensor 200 is disposed within a flow passage 84 in the intake pipe 81.

The gas sensor 200 includes the terminal housing unit 10, an attachment portion 15, a metal shell 16, and a protector 17 in order from the rear side BS to the front side AS. In addition, the gas sensor 200 includes the detection element 20 extending in the axial direction CD.

The detection element 20 (FIG. 3) has a plate shape, and has a first plate surface 20fa and an opposing second plate surface 20fb. The first plate surface 20fa and the second plate surface 20fb form principal surfaces of the detection element 20. Each of the first plate surface 20fa and the second plate surface 20fb is a surface having a largest area among outer surfaces of the detection element 20.

The detection element 20 includes a detection portion 21 located at the front side AS in the axial direction CD, and an element rear end portion 22 located at the rear side BS in the axial direction CD. The element rear end portion 22 includes first to third metal terminal portions 24a to 24c formed on the first plate surface 20fa, and fourth and fifth metal terminal portions 24d and 24e formed on the second plate surface 20fb. Each of the metal terminal portions 24a to 24e is formed of a metal such as platinum, or a member having electrical conductivity, and has a substantially rectangular surface shape. The second metal terminal portion 24b is located at the rear side BS relative to the other metal terminal portions 24a, 24c, 24d, and 24e. Here, in the case where the first to fifth metal terminal portions 24a to 24e are considered without distinguishing one from another, the metal terminal portions 24a to 24e are generically referred to as the “metal terminal portions 24”. The detection portion 21 is used for detecting the concentration of a specific gas component (e.g., oxygen) in a measurement target gas. As shown in FIG. 1, a front side portion of the detection element 20 in which the detection portion 21 is located is covered with a detection portion protection layer 90 that is formed of a porous member. The detection portion protection layer 90 inhibits impurities (e.g., water) included in the measurement target gas from being attached to the detection portion 21.

The detection element 20 (FIG. 3) used as an air-fuel ratio sensor has the same configuration as that of a conventional detection element, and thus a detailed description of the internal structure and the like thereof is omitted, but a schematic configuration thereof will be described below. The detection element 20 is a laminate of a plate-shaped element layer 28 having the detection portion 21 formed therein and a plate-shaped heater layer 29 that is used for heating the element layer 28. The element layer 28 has a configuration in which a solid electrolyte containing zirconia as a main component and a pair of electrodes each containing platinum as a main component are laminated via an insulating layer in a part of which a hollow measurement chamber is formed. The element layer 28 includes an oxygen pump cell in which one electrode (also referred to as “first electrode”) of the pair of electrodes formed on both surfaces of the solid electrolyte is exposed to the outside and the other electrode (also referred to as “second electrode”) of the pair of electrodes is disposed in the measurement chamber, and one of the pair of electrodes formed on both surfaces of the solid electrolyte is disposed in the measurement chamber. In addition, the element layer 28 includes an oxygen concentration measurement cell in which the second electrode is disposed in a reference gas chamber. The element layer 28 is configured such that oxygen in the measurement chamber is pumped out or oxygen is pumped from the outside into the measurement chamber. This oxygen pumping is carried out by controlling an electric current flowing between the pair of electrodes of the oxygen pump cell such that an output voltage of the oxygen concentration measurement cell has a predetermined value. The pair of electrodes of the oxygen pump cell and a portion of the solid electrolyte that is interposed between these electrodes form the detection portion 21 through which an electric current corresponding to an oxygen concentration flows. The metal terminal portion 24 is used for extracting a detection signal from the detection portion 21 or supplying power to a heating wire embedded in the heater layer 29.

The terminal housing unit 10 (FIG. 1) includes: a bottomed-tube-shaped separator portion 30 having a bottom portion 31 at the rear side BS; and a bottomed-tube-shaped base portion 40 having the bottom portion 31 as its own bottom portion. That is, the separator portion 30 and the base portion 40 share the same bottom portion. The base portion 40 includes a tubular main body portion 41 surrounding the outer periphery of the separator portion 30, and a connector portion 50 extending from the main body portion 41 in a direction intersecting the axial direction CD. In the present embodiment, the connector portion 50 extends in a direction orthogonal to the axial direction CD. The terminal housing unit 10 is integrally formed of a resin member. Resins having excellent moldability, such as nylon (registered trademark), PA (polyamide), PBT (polybutylene terephthalate), and PPS (polyphenylene sulfide) may be used as the resin member.

The separator portion 30 (FIG. 2) includes: first to sixth housing space portions 34a to 34f for housing the detection element 20 and later-described connection terminals 60; and a partition 35 separating the six housing space portions 34a to 34f from each other. As shown in FIG. 1, the partition 35 is composed of a plurality of plate-shaped members extending from the bottom portion 31 to the vicinity of the front-side end surface of the separator portion 30. On a plane orthogonal to the axial direction CD, the partition 35 separates the first to sixth housing space portions 34a to 34f from each other. As shown in FIG. 2, the first to fifth connection terminals 60a to 60e are housed in the first to fifth housing space portions 34a to 34e, respectively. The element rear end portion 22 of the detection element 20 and portions of the first to fifth connection terminals 60a to 60e (specifically, portions of element contact portions of the first to fifth connection terminals 60a to 60e) are housed in the sixth housing space portion 34f.

When the separator portion 30 is viewed from the front side AS, the sixth housing space portion 34f is disposed substantially at the center of the tubular separator portion 30, and the first to fifth housing space portions 34a to 34e are disposed outward in the radial direction of the separator portion 30 with respect to the sixth housing space portion 34f. Here, in the case where the first to sixth housing space portions 34a to 34f are considered without distinguishing one from another, the housing space portions 34a to 34f are generically referred to as the “housing space portions 34”. In addition, in the case where the first to fifth connection terminals 60a to 60e are considered without distinguishing one from another, the connection terminals 60a to 60e are generically referred to as the “connection terminals 60”.

The main body portion 41 (FIG. 2) of the base portion 40 includes a side portion 44 surrounding the outer periphery of the separator portion 30. The side portion 44 extends from a peripheral edge portion of the bottom portion 31 located at the rear side BS in the axial direction CD to the front side AS in the axial direction CD. The side portion 44 is disposed so as to surround the periphery of the separator portion 30 in the radial direction. As shown in FIG. 1, the partition 35 and the side portion 44 are indirectly connected via the bottom portion 31. In addition, as shown in FIG. 2, the partition 35 and the side portion 44 are directly connected to each other at least at the front side AS.

Connector terminals 52 (specifically, one end portion 54 of each connector terminal 52) for extracting a detection signal outputted from the detection element 20 to the outside are housed within the connector portion 50 (FIG. 1). Five connector terminals 52 are provided corresponding to the number of the connection terminals 60 (only one of them is shown in FIG. 1). The connector terminals 52 are mounted to the base portion 40 through insert molding into the base portion 40.

The other end portions 56 of the respective connector terminals 52 are electrically connected to the corresponding connection terminals 60 within the first to fifth housing space portions 34a to 34e. The one end portions 54 of the connector terminals 52 are disposed within an opening portion 58 of the connector portion 50. External connectors are inserted into the opening portion 58, whereby terminals disposed within the external connectors are electrically connected to the one end portions 54 of the connector terminals 52. Thus, a detection signal is transmitted via the external connectors to a measurement device for calculating an oxygen concentration.

The metal shell 16 is a tubular member in which the detection element 20 is disposed. The metal shell 16 is formed of stainless steel such as SUS430. The metal shell 16 surrounds the periphery of the detection element 20 around the axial direction CD. The metal shell 16 holds the detection element 20 such that the detection portion 21 of the detection element 20 projects from the front side AS, and the element rear end portion 22 thereof projects from the rear side BS. The attachment portion 15 is mounted on a rear-side outer circumferential portion 168 of the metal shell 16, located at the rear side BS, by laser welding or the like. The protector 17 is mounted on a front-side outer circumferential portion 167 of the metal shell 16, located at the front side AS, by laser welding.

The gas sensor 200 (FIG. 1) further includes a ceramic holder 175, a powder-charged layer 173, and a ceramic sleeve 171. Moreover, a crimp ring 157 is disposed between the ceramic sleeve 171 and a rear end portion 164 of the metal shell 16.

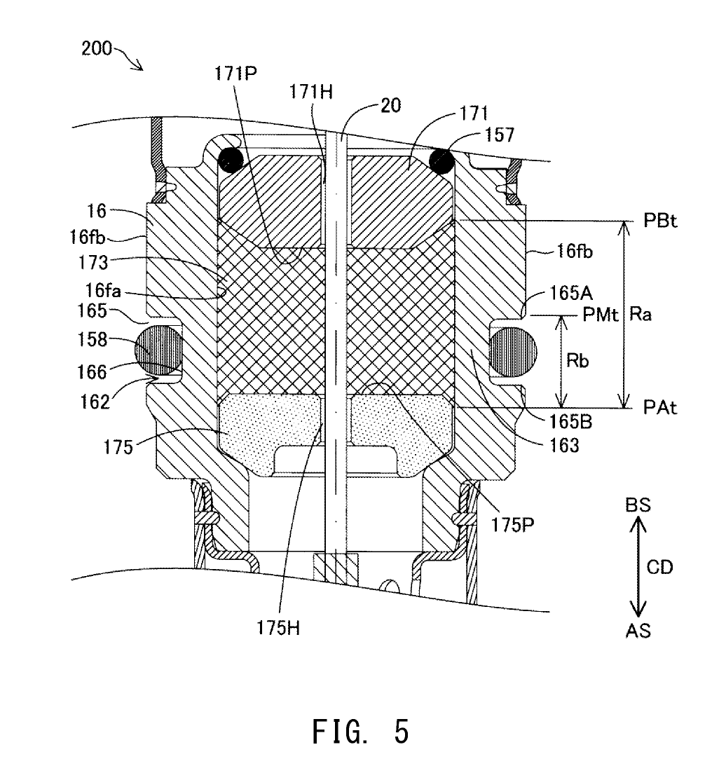

The ceramic holder 175 and the ceramic sleeve 171 are formed of alumina. The ceramic sleeve 171 and the ceramic holder 175 are tubular bodies having rectangular axial holes 171H and 175H along the axial direction CD (see FIG. 5). The plate-shaped detection element 20 is inserted into the rectangular axial holes 171H and 175H of the ceramic sleeve 171 and the ceramic holder 175. The axial hole 171H of the ceramic sleeve 171 is also referred to as first insertion hole 171H, and the axial hole 175H of the ceramic holder 175 is also referred to as second insertion hole 175H.

The ceramic holder 175 is disposed at the front side AS with respect to the powder-charged layer 173. The ceramic holder 175 is engaged with a ledge portion 169, of the metal shell 16, located at the front side AS.

The ceramic sleeve 171 is disposed at the rear side BS of the powder-charged layer 173. The ceramic sleeve 171 is a member for pressing talc powder forming the powder-charged layer 173 toward the front side AS. The crimp ring 157 is disposed at the rear side of the ceramic sleeve 171. After the ceramic sleeve 171 is placed within the metal shell 16, the ceramic sleeve 171 is fixed within the metal shell 16 via the crimp ring 157 by crimping the rear end portion 164 of the metal shell 16 inward in the radial direction toward the rear end surface of the ceramic sleeve 171.

The powder-charged layer 173 is formed by charging and compressing the talc powder as powder material into the metal shell 16. The detection element 20 is inserted into the powder-charged layer 173. The powder-charged layer 173 is disposed between the outer surface of the detection element 20 and an inner surface 16fa of the metal shell 16 such that the powder-charged layer 173 is in direct contact with the inner surface 16fa of the metal shell 16.

The metal shell 16 further has a groove 162 formed on an outer surface 16fb of the metal shell 16 along its circumferential direction. A seal member 158 for sealing a gap between the suction pipe 81 and the metal shell 16 is disposed in the groove 162. In the present embodiment, the seal member 158 is an O-ring. When the gas sensor 200 is mounted onto the suction pipe 81, the seal member 158 is elastically deformed by being pressed against an inner wall of a sensor mounting hole of the suction pipe 81. Due to the elastic deformation of the seal member 158, a gap between the sensor mounting hole and the gas sensor 200 is sealed.

The protector 17 (FIG. 1) includes an external protector 18, and an internal protector 19 located inside the external protector 18. Each of the external protector 18 and the internal protector 19 has a bottomed tube shape. Each of the external protector 18 and the internal protector 19 is a member made of a metal and having a plurality of holes. A measurement target gas flows into the internal protector 19 through these holes. The external protector 18 and the internal protector 19 cover the detection portion 21 of the detection element 20, thereby inhibiting foreign matter (e.g., water) flowing within the flow passage 84 from being attached to the detection portion 21.

The attachment portion 15 is a member connecting the metal shell 16 and the terminal housing unit 10. The attachment portion 15 is a member made of a metal such as stainless steel. A portion of the attachment portion 15, located at the front side AS, is mounted on the metal shell 16 by laser welding or the like, and a portion of the attachment portion 15, located at the rear side BS, is mounted on the base portion 40 of the terminal housing unit 10 by crimping. A seal member 159 is disposed in a groove 411 formed on a front-side end surface of the base portion 40 (specifically, the main body portion 41). The seal member 159 is an O-ring. This seal member 159 seals an attachment portion between the attachment portion 15 and the base portion 40. The attachment portion 15 includes a pair of flange portions (not shown) projecting in a direction perpendicular to the sheet surface of FIG. 1. Holes are formed in the flange portions. The sensor 200 is mounted onto a mounting target by inserting screws into the holes and screwing the screws into screw holes formed in the mounting target. The number of the screw holes may be one or may be a plural number.

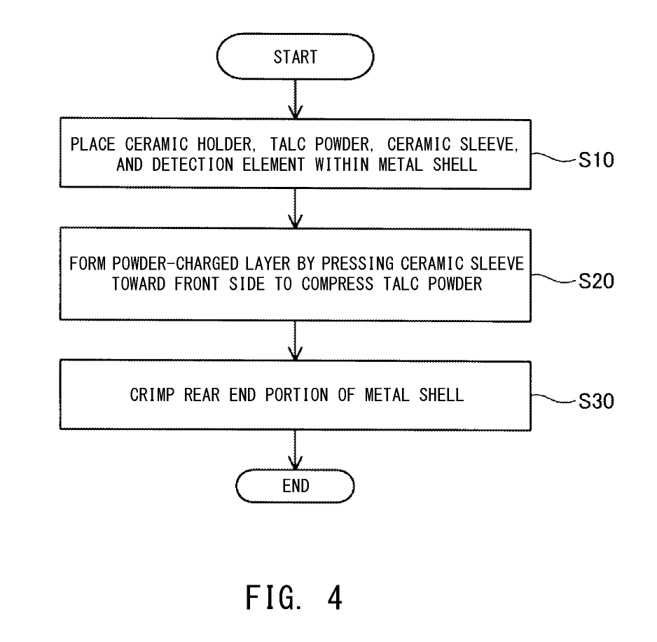

FIG. 4 is a chart of a process for forming the powder-charged layer 173. First, the ceramic holder 175, the talc powder, the ceramic sleeve 171, and the detection element 20 are placed within the metal shell 16 (step S10). Specifically, after the ceramic holder 175 is engaged with the ledge portion 169 (FIG. 1), the detection element 20 is inserted into the axial hole 175H of the ceramic holder 175. Then, the talc powder and the ceramic sleeve 171 are stacked on the ceramic holder 175 in this order. Next, the ceramic sleeve 171 is pressed from the rear side BS toward the front side AS using a jig to compress the talc powder to form the powder-charged layer 173 (step S20). While the talc powder is compressed in the axial direction CD, pressure toward the outer side in the radial direction is applied to the metal shell 16 by the talc powder. Finally, the crimp ring 157 is placed at the rear side (the upper side in the drawing) of the ceramic sleeve 171, and then the rear end portion 164 of the metal shell 16 is crimped (step S30). The powder-charged layer 173 allows the detection element 20 to be held within the metal shell 16 and also allows the interior of the metal shell 16 to be kept airtight. Regarding the ceramic holder 175 as a second member, the area of a flat portion 175P perpendicular to the axial direction CD, of a surface (rear end surface) that is in contact with the powder-charged layer 173, is referred to as area S2. In addition, regarding the ceramic sleeve 171 as a first member, the area of a flat portion 171P perpendicular to the axial direction CD, of a surface (front end surface) that is in contact with the powder-charged layer 173, is referred to as area S1. In this case, the area S2 is larger than the area S1. When the area of the flat portion perpendicular to the axial direction CD, of the portion that is in contact with the powder-charged layer 173, is larger, the pressure received from the powder-charged layer 173 can be dispersed and decreased. According to the present embodiment, since the area S2 of the flat portion 175P of the ceramic holder 175 is larger than the area S1 of the flat portion 171P of the ceramic sleeve 171, the pressure applied to the front side of the metal shell 16 can be decreased, so that deformation of a portion of the metal shell 16 in which an opening 165 is formed can be inhibited.

FIG. 5 is a partially enlarged view of the gas sensor 200. The detailed configuration of the groove 162 and arrangement positions will be described with reference to FIG. 5. Here, a range in which the powder-charged layer 173 is disposed, in the axial direction CD, is referred to as first range Ra. In addition, a center between a front end PAt and a rear end PBt of the first range Ra in the axial direction CD is referred to as a center portion PMt. Moreover, a range from the center portion PMt to the front end PAt in the axial direction CD is referred to as a front end range Rb.

The groove 162 has the opening 165 at the outer side in the radial direction of the metal shell 16. In the metal shell 16, a rear side BS end portion defining the opening 165 is referred to as first end portion 165A, and a front side AS end portion is referred to as second end portion 165B. The opening 165 is opened in a direction perpendicular to the axial direction CD. That is, the groove 162 is formed over a predetermined length in the axial direction CD. The groove 162 further has a bottom surface 166 opposed to the opening 165 in the radial direction of the metal shell 16 (the right-left direction in FIG. 5). The bottom surface 166 extends parallel to the axial direction CD. That is, the groove 162 has a uniform depth. A portion (groove-formed portion) of the metal shell 16 on which the groove 162 is formed has a small thickness in the radial direction in the first range Ra. Of this portion, a portion on which the bottom surface 166 is formed has a smallest thickness in the radial direction. Thus, the portion having the smallest thickness in the radial direction is also referred to as the thin portion 163. In the axial direction CD, the entirety of the groove 162 and the thin portion 163 are located in the front end range Rb.

In this embodiment, the powder-charged layer 173 is formed by pressing the talc powder from the rear side BS toward the front side AS so as to be compressed along the axial direction CD. Accordingly, when forming the powder-charged layer 173, the pressure in the metal shell 16 becomes high, so that the metal shell 16 may deform so as to expand outward in the radial direction. In particular, at the rear side BS which is a starting point for pressing the talc powder, the pressure in the metal shell 16 becomes higher than that at the front side AS. That is, when forming the powder-charged layer 173, the pressure applied to a portion of the metal shell 16, located in the front end range Rb, is lower than the pressure applied in a range from the center portion PMt to the rear end PBt of the first range Ra (in a rear end range). According to the first embodiment, the entirety of the groove 162 is located between the center portion PMt and the front end PAt of the first range Ra (in the front end range Rb) (FIG. 5). Thus, when forming the powder-charged layer 173, the pressure applied to the portion of the metal shell 16 on which the groove 162 is located (the thin portion 163) can be reduced, so that deformation of the thin portion 163 and the groove 162 can be inhibited without increasing the thickness, in the radial direction, of the thin portion 163.

According to the first embodiment, the seal member 158 is disposed in the groove 162. Thus, the gap between the suction pipe 81 and the metal shell 16 can be sealed, to thereby inhibit the intake gas from leaking to the outside. In addition, in the first embodiment, since deformation of the groove 162 can be inhibited, displacement of the seal member 158 can be inhibited. Moreover, the groove 162 has a uniform depth, and has the bottom surface 166 extending along the axial direction CD. Thus, the seal member 158 can be stably disposed in the groove 162.

### B. Second Embodiment

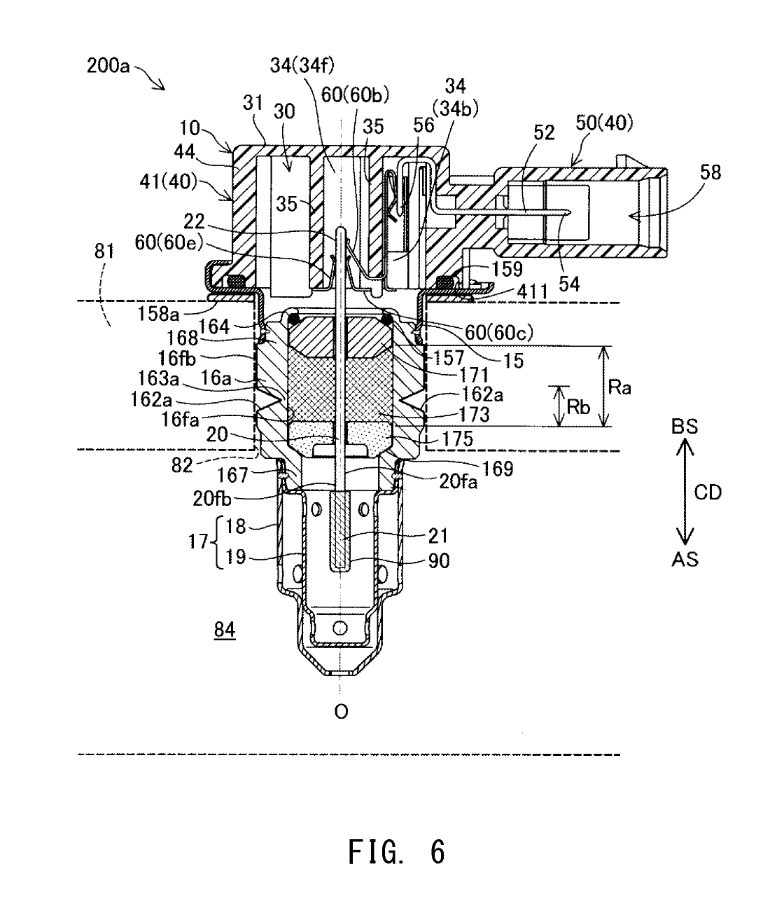

FIG. 6 is a cross-sectional view of a gas sensor 200a according to a second embodiment of the present invention. The gas sensor 200a according to the second embodiment is different from the gas sensor 200 according to the first embodiment with respect to the shape of a groove 162a and a position at which a seal member 158a is disposed. As to the remaining configuration, the gas sensor 200a according to the second embodiment is the same as the gas sensor 200 according to the first embodiment. Thus, the same components are designated by the same reference numerals and the description thereof is omitted.

A metal shell 16a of the gas sensor 200a has the groove 162a formed on the outer surface 16fb thereof along the circumferential direction thereof. The groove 162a has a tapered shape that is reduced in diameter from the radially outer side toward the radially inner side. In the present embodiment, the cross-sectional shape of the groove 162a parallel to the axial direction CD is a V shape. The metal shell 16a has a thin portion 163a at a position, in the axial direction CD, at which the groove 162a is formed. The thin portion 163a is a portion having a smallest thickness in the radial direction, of the metal shell 16a located in the first range Ra in the axial direction CD. That is, in the present embodiment, the thin portion 163a is located at a position corresponding to a deepest portion (the tip of V) of the V shape of the groove 162a. The entirety of the groove 162a and the entirety of the thin portion 163a are located in the front end range Rb in the axial direction CD. The groove 162a is formed for reducing the weight of the metal shell 16a. In addition, in another embodiment, the groove 162a may be used for heat dissipation. Moreover, a plurality of grooves 162a may be formed at different positions in the axial direction CD.

The seal member 158a is disposed on a portion of the attachment portion 15 that projects outward in the radial direction. The seal member 158a is an O-ring. The seal member 158a seals a gap between the gas sensor 200a and the suction pipe 81.

According to the second embodiment, the entirety of the thin portion 163a is located between the center portion PMt and the front end PAt of the first range Ra (in the front end range Rb) (FIG. 6). Thus, during formation of the powder-charged layer 173, the pressure applied to the thin portion 163a of the metal shell 16 can be reduced, so that deformation of the thin portion 163a and the groove 162a can be inhibited without increasing the thickness, in the radial direction, of the thin portion 163a.

### C. Modified Embodiments

The present invention is not limited to the above embodiments and additional modes and may be embodied in various other forms without departing from the scope of the invention.

### C-1. First Modified Embodiment

Although the entirety of the grooves 162 and 162a and the entirety of the thin portions 163 and 163a are located in the front end range Rb in the first and second embodiments described above, the present invention is not limited thereto. For example, in the first embodiment, one-half or more of each of the opening 165 and the thin portion 163 (FIG. 5) may be located in the front end range Rb. In addition, for example, in the second embodiment, in the case where the thin portion 163a has a length in the axial direction CD, one-half or more of the thin portion 163a may be located in the front end range Rb. Even with this configuration, similarly to the first and second embodiments described above, deformation of the thin portions 163 and 163a and the grooves 162 and 162a can be inhibited without increasing the thicknesses, in the radial direction, of the thin portions 163 and 163a. Here, one-half or more of each of the opening 165 and the thin portions 163 and 163a means one-half or more of each of the lengths, along the axial direction CD, of the opening 165 and the thin portions 163 and 163a.

### C-2. Second Modified Embodiment

Although the seal member 158 is disposed in the groove 162 as shown in FIG. 1 in the first embodiment described above, the seal member 158 need not be disposed therein. In this case, in the gas sensor 200 according to the first embodiment, the seal member 158a (FIG. 6) may be disposed at the same portion as in the gas sensor 200a according to the second embodiment. In addition, although the seal member 158a is disposed at a portion different from the groove 162a in the second embodiment described above, the seal member 158a may be disposed in the groove 162a.

### C-3. Third Modified Embodiment

Although the outer surface of the thin portion 163a has a V shape (FIG. 6) in the second embodiment described above, the present invention is not limited thereto. For example, similarly to the thin portion 163 of the first embodiment, the thin portion 163a may have an outer surface extending parallel to the axial direction CD. At the thin portion 163a having an outer surface extending parallel to the axial direction CD, a shape having the opening 165 and the bottom surface 166 (the outer surface of the thin portion 163a) opposed to the opening 165 is formed.

### C-4. Fourth Modified Embodiment

Although each of the gas sensors 200 and 200a according to the first and second embodiments described above is an oxygen sensor that measures an oxygen concentration in an intake gas flowing through the suction pipe 81, the present invention is not limited thereto, and can be applied to gas sensors for measuring the concentrations of various specific gases. For example, each of the gas sensors 200 and 200a may be a sensor for measuring NOx concentration in an exhaust gas flowing through an exhaust pipe of an engine.

The invention has been described in detail with reference to the above embodiments. However, the invention should not be construed as being limited thereto. It should further be apparent to those skilled in the art that various changes in form and detail of the invention as shown and described above may be made. It is intended that such changes be included within the spirit and scope of the claims appended hereto.

This application is based on Japanese Patent Application No. 2015-162505 filed Aug. 20, 2015, the above-noted application incorporated herein by reference in its entirety.

What is claimed is:

1. A gas sensor comprising:
a detection element extending in an axial direction and having, at a front side in the axial direction, a detection portion for detecting a concentration of a specific gas;
a tubular metal shell surrounding a periphery of the detection element; and
a powder-charged layer disposed between an outer surface of the detection element and an inner surface of the metal shell such that the powder-charged layer is in direct contact with the inner surface of the metal shell, wherein
the metal shell has a groove having an opening formed on an outer surface of the metal shell in a circumferential direction thereof,
in the axial direction, one-half or more of the opening is located between a center portion that is a center of the powder-charged layer and a front end, in the axial direction, of the powder-charged layer.

2. The gas sensor as claimed in claim 1, wherein a seal member for sealing a gap between the metal shell and a mounting target on which the gas sensor is to be mounted is disposed in the groove.

3. The gas sensor as claimed in claim 1, wherein the groove has a bottom surface opposed to the opening in a radial direction.

4. The gas sensor as claimed in claim 1, wherein an entirety of the groove is located between the center portion and the front end of the powder-charged layer.

5. The gas sensor as claimed in claim 1, further comprising:
a first member having a first insertion hole into which the detection element is inserted, the first member being disposed within the metal shell and at a rear side in the axial direction with respect to the powder-charged layer, the detection element having been inserted into the first insertion hole so as to compress the powder-charged layer; and
a second member having a second insertion hole into which the detection element is inserted, the second member being disposed within the metal shell and at the front side in the axial direction with respect to the powder-charged layer, the detection element having been inserted into the second insertion hole so as to compress the powder-charged layer, wherein
an area S2 of a surface perpendicular to the axial direction, of a surface of the second member that is in contact with the powder-charged layer, is larger than an area S1 of a surface perpendicular to the axial direction, of a surface of the first member that is in contact with the powder-charged layer.

6. A gas sensor comprising:
a detection element extending in an axial direction and having, at a front side in the axial direction, a detection portion for detecting a concentration of a specific gas;
a tubular metal shell surrounding a periphery of the detection element; and
a powder-charged layer disposed between an outer surface of the detection element and an inner surface of the metal shell such that the powder-charged layer is in direct contact with the inner surface of the metal shell, wherein
the metal shell has, in the axial direction, a thin portion having a smallest thickness in a radial direction, of a portion that at least partially overlaps the powder-charged layer, and
in the axial direction, one-half or more of the thin portion is located between a center portion that is a center of the powder-charged layer and a front end, in the axial direction, of the powder-charged layer.

7. The gas sensor as claimed in claim 6, wherein a seal member for sealing a gap between the metal shell and a mounting target on which the gas sensor is to be mounted is disposed at the thin portion.

8. The gas sensor as claimed in claim 6, wherein the thin portion has an outer surface extending in the axial direction.

9. The gas sensor as claimed in claim 6, wherein an entirety of the thin portion is located between the center portion and the front end of the powder-charged layer.

10. The gas sensor as claimed in claim 6, further comprising:
a first member having a first insertion hole into which the detection element is inserted, the first member being disposed within the metal shell and at a rear side in the axial direction with respect to the powder-charged layer, the detection element having been inserted into the first insertion hole so as to compress the powder-charged layer; and
a second member having a second insertion hole into which the detection element is inserted, the second member being disposed within the metal shell and at the front side in the axial direction with respect to the powder-charged layer, the detection element having been inserted into the second insertion hole so as to compress the powder-charged layer, wherein
an area S2 of a surface perpendicular to the axial direction, of a surface of the second member that is in contact with the powder-charged layer, is larger than an area S1 of a surface perpendicular to the axial direction, of a surface of the first member that is in contact with the powder-charged layer.
